(19) United States
(12) Patent Application Publication
(10) Pub. No.: US 2014/0095593 A1
(43) Pub. Date: Apr. 3, 2014

(54) METHOD AND APPARATUS FOR TRANSMITTING DATA FILE TO CLIENT

(71) Applicant: Huawei Technologies Co., Ltd., Shenzhen (CN)

(72) Inventor: Anni Wei, Beijing (CN)

(73) Assignee: Huawei Technologies Co., Ltd., Shenzhen (CN)

(21) Appl. No.: 14/100,519

(22) Filed: Dec. 9, 2013

Related U.S. Application Data
(63) Continuation of application No. PCT/CN2012/077100, filed on Jun. 18, 2012.

(30) Foreign Application Priority Data
Jun. 16, 2011 (CN) 201110162931.8

(51) Int. Cl. H04L 29/06

(52) U.S. Cl. CPC H04L 65/602
USPC 709/203

(57) ABSTRACT

Embodiments of the present invention provide a method and an apparatus for transmitting a data file to a client. The method mainly includes: storing a data file with different bit rates or resolutions in a server, obtaining state information of a network resource between a client and the server, and sending bit rate or resolution adjustment indication information to the client according to the state information of the network resource, so that the client can request the server for a data file with a bit rate or resolution matching the state information of the network resource. By using the present invention, the client can request the server for a data file with a bit rate or resolution level matching the network resource, thereby increasing resource utilization of the server.

CROSS-REFERENCE

This application is a continuation of International Application No. PCT/CN2012/077100, filed on Jun. 18, 2012, which claims priority to Chinese Patent Application No. 201110162931.8, filed on Jun. 16, 2011, both of which are hereby incorporated by reference in their entireties.

### TECHNICAL FIELD

The present invention relates to the field of wireless communication technologies, and in particular, to a method and an apparatus for transmitting a data file to a client.

### BACKGROUND

A streaming media refers to a media that publishes audio and video multimedia contents in real time on the Internet in the form of data streams, and a streaming media technology is a technology used to publish multimedia data streams on an IP network. In a traditional playing technology, a client downloads a complete media file from a server, and then plays the media file. However, the streaming media technology uses a streaming transmission mode, in which a whole multimedia file is compressed and encoded into multiple compressed packages and the compressed packets are transmitted to the client sequentially on a real-time basis; a user can download subsequent compressed packages while decompressing and playing the previously transmitted compressed packages.

Common streaming media transmission technologies mainly include an RTSP (Real Time Streaming Protocol, Real Time Streaming Protocol), HTTP progressive download (HTTP progressive download), and HTTP Streaming (HTTP streaming).

The HTTP Progressive Download is the most popular technology used to watch videos on the Internet. Currently, domestic and foreign mainstream video websites, for example, YouTube, youku, tudou, Sixth Room, and the like, has used the HTTP Progressive Download technology. A video player of a client downloads a video file from a server by using the HTTP (HyperText Transfer Protocol, HyperText Transfer Protocol) protocol; after receiving enough video data, the video player begins to play the video, and meanwhile continues to download video data from the server. If the speed of downloading the video data exceeds the playing rate, the video player stores the video data file in a local buffer. If the speed of downloading the video data is lower than the playing rate, the video player stops playing, but the server still sends video data to the client until the whole file is downloaded completely or the user closes the video.

During implementation of the present invention, the inventor finds that the prior art has at least the following problems: When a same video file has multiple versions of bit rates or resolutions, the foregoing progressive download mode only allows a user to manually select a video file of a certain bit rate or resolution for downloading and playing; or a video website provides a certain video file of a default bit rate or resolution for the client to download and play, which may cause a case that the video file downloaded by the client does not match a network resource of the client.

### SUMMARY

Embodiments of the present invention provide a method and an apparatus for transmitting a data file to a client, so as to send a data file with a corresponding bit rate or resolution level to the client according to state information of a network resource between the client and the server.

A method for transmitting a data file to a client includes storing data files with different bit rates or resolutions in a server, and the method specifically includes:

obtaining state information of a network resource between a client and a server; and

sending, according to the state information of the network resource, bit rate or resolution adjustment indication information to the client, so that the client requests the server for a data file with a bit rate or resolution matching the state information of the network resource.

An apparatus for transmitting a data file to a client includes:

a network resource state information obtaining module, configured to obtain state information of a network resource between a client and a server; and

a bit rate or resolution adjustment indication information sending module, configured to send bit rate or resolution adjustment indication information to the client according to the state information of the network resource obtained by the network resource state information obtaining module, so that the client requests the server for a data file with a bit rate or resolution matching the state information of the network resource.

According to the foregoing technical solutions provided by the embodiments of the present invention, in the embodiments of the present invention, a network side obtains state information of a network resource between a client and a server, and sends bit rate or resolution adjustment indication information to the client according to the state information of the network resource, so that the client can request the server for a data file with a bit rate or resolution level matching the network resource, thereby increasing resource utilization of the server.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a processing flowchart of a method for transmitting a data file to a client according to Embodiment 1 of the present invention;

FIG. 2 is a schematic structural diagram of an OVSF code tree according to Embodiment 2 of the present invention;

FIG. 3 is a structural diagram of an HTTP Proxy (proxy)-based architecture of sending a media stream to a client according to Embodiment 2 of the present invention;

FIG. 4 is a processing flowchart of a method for transmitting a media file to a client according to Embodiment 2 of the present invention;

FIG. 5 is a processing flowchart of a method for transmitting a media file to a client according to Embodiment 3 of the present invention; and

FIG. 6 is a specific structural diagram of an apparatus for transmitting a data file to a client according to an embodiment of the present invention.

### DESCRIPTION OF EMBODIMENTS

To make the objectives, technical solutions, and advantages of the embodiments of the present invention more comprehensible, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

For better understanding of the embodiments of the present invention, the present invention is further described with reference to the accompanying drawings and several exemplary embodiments, and each embodiment does not constitute a limitation on the embodiments of the present invention.

### Embodiment 1

In this embodiment, firstly data files of different bit rates or resolutions need to be stored in a server. A specific processing process may be as follows: a data file is split into multiple fragments; multiple versions with different bit rates or resolutions are constructed with respect to each fragment; each fragment and description information of each fragment of the data file are stored, where the description information of each fragment includes information about the multiple bit rates or resolutions and a resource address corresponding to each fragment;

or,

multiple versions with different bit rates or resolutions are constructed with respect to a whole data file, and the data file and description information of the data file are stored, where the description information of the data file includes information about the multiple bit rates or resolutions and a resource address corresponding to the data file.

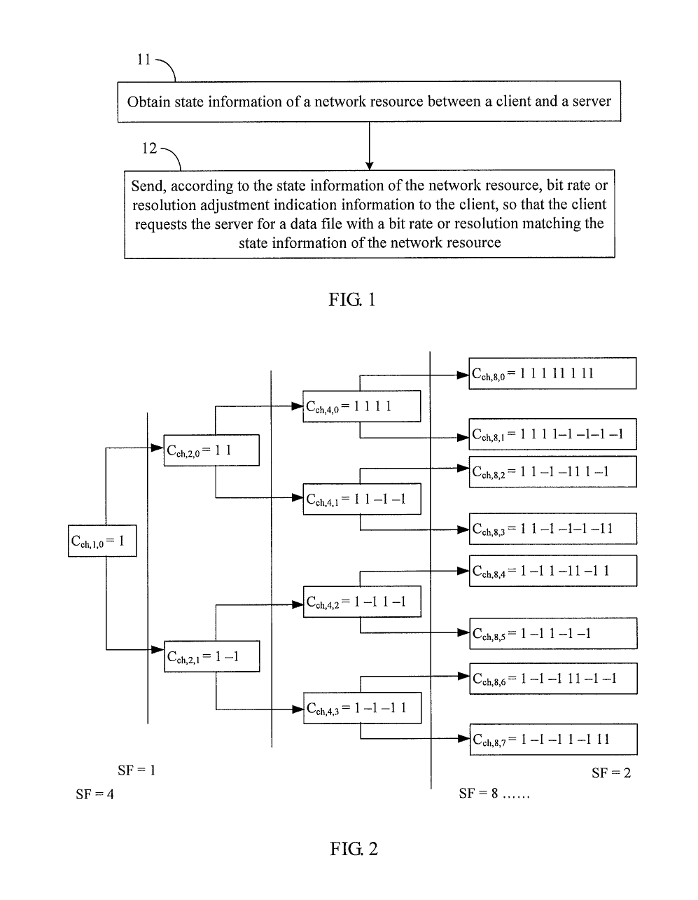

As shown in FIG. 1, a processing process of a method for transmitting a data file to a client according to this embodiment includes the following processing steps:

Step 11: Obtain state information of a network resource between a client and a server.

Detect a state of a current downlink network resource between the server and the client in real time on the server side to obtain a value of the current downlink network resource between the server and the client.

The foregoing client and server may be an HTTP Streaming Client and an HTTP Streaming Sever or a Progressive Download client and a Progressive Download sever.

Further, whether the value of the current downlink network resource between the server and the client is greater than a preset resource threshold is determined; if the value is greater than the threshold, it is determined that the state of the downlink network resource between the client and the server is congested; otherwise, it is determined that the state of the downlink network resource between the client and the server is normal.

The current network resource between the client and the server includes at least one of the following: a code resource, an Iub (an interface between a base station and a base station controller) interface transmission resource, a credit resource, and a power resource.

When the network resource is a code resource, whether the state of the current downlink code resource between the server and the client is congested is determined by using the following equation:

When Min_SF>Thd_SF, it is determined that the state of the downlink code resource is congested; otherwise, it is determined that the state of the downlink code resource is normal, where

Min_SF represents a smallest idle SF (Spreading Factor, spreading factor) in a cell code tree, and Thd_SF represents a configured SF reservation threshold.

For WCDMA (Wideband Code Division Multiple Access, wideband code division multiple access), a selected spreading code is OVSF (Orthogonal Variable Spreading Factor, orthogonal variable spreading factor), where the OVSF is described by using a tree structure. Assuming that an initial root assignment is Cch,1,0=1; when SF=1 is changed to SF=2, a first bit of a first subtree is reserved and a second bit of the first subtree is copied, and Cch,2,0=1 1; a first bit of a second subtree is reserved, a phase deflection is performed on a second bit of the second subtree, and Cch,2,1=1 −1. The rest may be deduced by analogy. A mechanism of generating a subtree when SF=4 is the same as that when SF=2. A structure of an OVSF code tree according to this embodiment is shown in FIG. 2.

In the structure of the OVSF code tree, each order corresponds to one SF value; for example, when SF=2, there are 2 available code words in a same order; when SF=4, there are 4 available code words in a same order. The rest may be deduced by analogy. When SF=8, there are 8 available code words in a same order. An identifier of a code word is Cch,SF,no.

Assuming that the configured reservation threshold Thd_SF of the SF is 4 but code words that have been used are Cch,4,0=1 1 1 1, Cch,4,1=1 1 −1 −1, Cch,4,2=1 −1 1 −1, and Cch,8,6=1 −1 −1 11 −1 −1 1, the smallest idle SF in the cell code tree Min_SF is 8, that is, Min_SF>Thd_SF. In this case, it can be determined that the state of the downlink code resource is congested.

Step 12: Send, according to the state information of the network resource, bit rate or resolution adjustment indication information to the client, so that the client requests the server for a data file with a bit rate or resolution matching the state information of the network resource.

Information about the bit rate or resolution of the data file matching the state information of the network resource and pre-stored in the server is determined according to the value of the current downlink network resource between the client and the server.

For example, when the network resource is a code resource, a value Vi of a current downlink data transmission rate between the server and the client is calculated as follows:

$$Vi = \frac{W}{Li} \times \frac{[ Pi ] \times gi}{RSSIi - [ Pi ] \times gi} ,$$

where

Vi is the downlink data transmission rate between client i and the server;

W and Li represent a bandwidth of the server and service quality of client i respectively;

Pi is a power sent by the server to client i;

RSSIi is a total reception power of client i; and

gi is a large-scale loss of a channel.

For example, if Vi is 640000 bps and bit rate levels of each fragment of the data file stored in the server include 350000 bps, 470000 bps, 630000 bps, 845000 bps, and 1130000 bps, it is determined that the bit rate 630000 bps matches the current downlink data transmission rate between the server and the client.

When the information about the bit rate or resolution of the data file requested by the client from the server is inconsistent with the information about the bit rate or resolution of the matched data file, the server may send bit rate or resolution adjustment indication information that carries reduction or addition indication information to the client, or send a redirection notification message that carries a resource address of the matched data file to the client.

For example, if the bit rate of a previous fragment of the data file requested by the client from the server is 845000 bps, because 845000 bps>630000 bps, the server sends bit rate adjustment indication information that carries reduction indication information to the client; after receiving the bit rate adjustment indication information, the client may choose to request the server for a next fragment of the data file with the bit rate of 630000 bps.

For another example, if the bit rate of a previous fragment of the data file requested by the client from the server is 470000 bps, because 470000 bps<630000 bps, the server sends bit rate adjustment indication information that carries addition indication information to the client; after receiving the bit rate adjustment indication information, the client may choose to request the server for a next fragment of the data file with the bit rate of 630000 bps.

For another example, when the bit rate of a previous fragment of the data file requested by the client from the server is inconsistent with 630000 bps, the server may send a redirection notification message that carries a resource address of a next fragment of the data file with the bit rate of 630000 bps; after receiving the redirection notification message, the client directly downloads a next fragment of the data file with the bit rate of 630000 bps according to the resource address information.

Further, whether the value of the current downlink network resource is greater than a preset resource threshold is determined; if the value is greater than the threshold, it is determined that the state of the downlink network resource between the client and the server is congested; otherwise, it is determined that the state of the downlink network resource between the client and the server is normal. When it is determined that the state of the downlink network resource between the client and the server is congested, bit rate or resolution adjustment indication information that carries reduction indication information is sent to the client.

For example, when the network resource is a code resource, assuming that the configured reservation threshold Thd_SF of the SF is 4 but code words that have been used are only Cch,8,0=1 1 1 11 1 1 1, Cch,8,1=1 1 1 1−1 −1−1 −1, and Cch,8,2=1 1 −1 −11 1 −1 −1 and other code words whose SF=8 are idle, the smallest idle SF in the cell code tree Min SF is 8, that is, Min_SF>Thd_SF. In this case, it is determined that the state of the downlink code resource between the client and the server is congested. Then, bit rate adjustment indication information that carries reduction indication information is sent to the client; when the bit rate of a previous fragment of the data file requested by the client from the server is 470000 bps, after receiving the bit rate adjustment indication information, the client may choose to request the server for a next fragment of the data file with the bit rate of 350000 bps.

According to the technical solution provided by the embodiment of the present invention, in the embodiment of the present invention, a network side obtains state information of a network resource between a client and a server, and sends, according to the state information of the network resource, bit rate or resolution adjustment indication information that carries bit rate or resolution reduction or addition indication information to the client, or sends bit rate or resolution adjustment indication information that carries a resource address of a matched data file to the client, so that the client can request the server for a data file with a bit rate or resolution matching the network resource, thereby increasing utilization of air interface resources between the server and the client and improving user experience.

### Embodiment 2

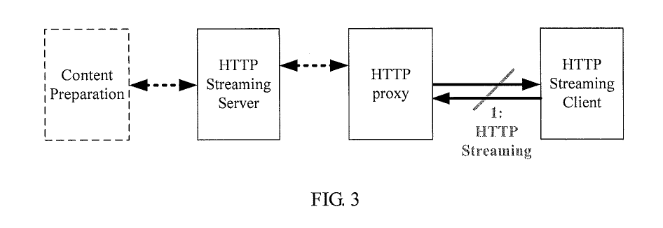

This embodiment provides a structure of an HTTP Proxy (proxy)-based architecture of sending a media stream to a client. As shown in FIG. 3, the architecture includes the following units:

a Content Preparation (content source), configured to split a media file into multiple fragments, construct multiple versions with different bit rates with respect to each fragment, encapsulate each fragment into a format (for example, a file fragment in a 3GP format) compliance with a requirement, and generate description information of each fragment, and then send each fragment and description information of each fragment of the media file to an HTTP Steaming Server (HTTP streaming server);

the HTTP Streaming Server, configured to store each fragment and description information of each fragment of the media file sent by the Content Preparation, generate a MPD (Media Presentation Description, media presentation description) of the whole media file, respond to a request for downloading a fragment of the media file from an HTTP Streaming Client (HTTP streaming client) sent by an HTTP proxy (HTTP proxy), and send a corresponding fragment of the media file to the HTTP proxy;

the HTTP proxy, configured to detect a state of a current downlink code resource between a server and a client, send bit rate adjustment indication information to the client according to the state information of the code resource, so that the client can request the server for a data file with a bit rate matching the state information of the code resource,

forward the request for downloading a fragment of the media file sent by the client to the HTTP Streaming Server, and forward the fragment of the media file sent by the HTTP Streaming Server to the HTTP Streaming Client; and

the HTTP Streaming Client, configured to send a request for downloading a fragment of the media file to the HTTP proxy according to the MPD of the media file obtained from the HTTP Streaming Server, and adjust, according to the bit rate adjustment indication information sent by the HTTP proxy, information about a bit rate corresponding to the fragment of the media file that is required to be downloaded in the request.

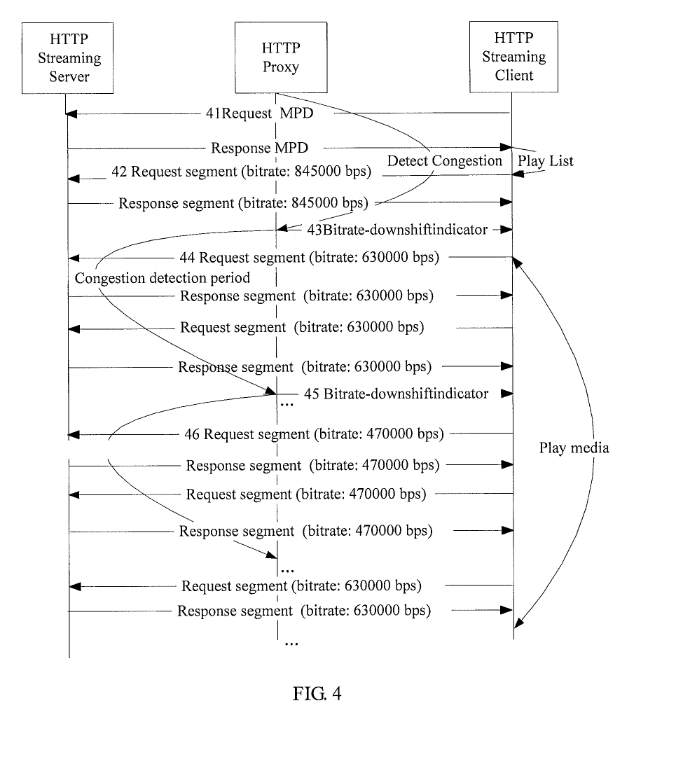

Based on the architecture illustrated in FIG. 3, this embodiment provides a processing process of a method for transmitting a data file to a client. As shown in FIG. 4, the method includes the following processing steps:

Step 41: An HTTP Streaming Client sends a request for obtaining an MPD of a media file to an HTTP Streaming Server through an HTTP proxy. The HTTP Streaming Server responds to the request, and sends the MPD of the media file to the HTTP Streaming Client through the HTTP proxy, where the MPD includes a resource addresses and description information of each fragment of the media file stored in the server, where the description information includes information about a bit rate level corresponding to each fragment.

Bit rate levels of each fragment of the media file include 350000 bps, 470000 bps, 630000 bps, 845000 bps, and 1130000 bps.

Step 42: The HTTP Streaming Client sends, according to the MPD of the media file, a request for obtaining a fragment with the bit rate level of 845000 bps to the HTTP Streaming Server through the HTTP proxy. The HTTP Streaming Server responds to the request, and sends a fragment with the bit rate level of 845000 bps to the HTTP Streaming Client through the HTTP proxy.

After receiving the request sent by the HTTP Streaming Client, the HTTP proxy detects a state of a current downlink code resource between the HTTP Streaming Server and the HTTP Streaming Client in real time, and determines whether a value of the current downlink code resource is greater than a preset resource threshold; if the value is greater than the threshold, the HTTP proxy determines that the state of the downlink code resource between the HTTP Streaming Server and the HTTP Streaming Client is congested; otherwise, the HTTP proxy determines that the state of the downlink code resource between the HTTP Streaming Server and the HTTP Streaming Client is normal.

Step 43: After determining that the state of the downlink code resource between the HTTP Streaming Server and the HTTP Streaming Client is congested, the HTTP proxy sends bit rate adjustment indication information that carries reduction indication information to the HTTP Streaming Client.

The bit rate adjustment indication information may be carried by using an option field or a TOS (Type of Service, type of service) field in an IP header domain of an IP message, or by using a TCP header domain of a TCP (Transmission Control Protocol, Transmission Control Protocol) message, or by using an HTTP header domain or a message body of an HTTP message.

The following is an example of carrying the bit rate adjustment indication information by using an HTTP Warning header domain of an HTTP message provided in this embodiment:

A format of the HTTP Warning header domain is as follows:

| | |
|---|---|
| Warning | = ″Warning″ ″:″ 1#warning-value |

warning-value = warn-code SP warn-agent SP warn-text

[SP warn-date]

warn-code = 3DIGIT
warn-agent = ( host [ ″:″ port ] ) | pseudonym

; the name or pseudonym of the server adding
; the Warning header, for use in debugging

warn-text = quoted-string
warn-date = <″> HTTP-date <“>

An example of the bit rate adjustment indication information is as follows: Warning=“Warning” “:” 1#114 BJRNC01 downshift “042511”.

After sending the bit rate adjustment indication information, the HTTP proxy starts an operation of counting a timing duration (for example, 10 s) of a bit rate adjustment timer; before the timing duration of the bit rate adjustment timer elapses, if the HTTP proxy detects that the state of the downlink code resource between the HTTP Streaming Server and the HTTP Streaming Client is congested again, the HTTP proxy does not send bit rate adjustment indication information that carries reduction indication information to the HTTP Streaming Client. The bit rate adjustment timer is configured to prevent frequent alarms due to network resource congestion.

Step 44: After receiving the bit rate adjustment indication information that carries reduction indication information, the HTTP Streaming Client sends, according to the reduction indication information, a request for obtaining a fragment with the bit rate level of 630000 bps to the HTTP Streaming Server through the HTTP proxy. The HTTP Streaming Server responds to the request, and sends a fragment with the bit rate level of 630000 bps to the HTTP Streaming Client through the HTTP proxy.

Step 45: After the timing duration of the bit rate adjustment timer elapses, if the HTTP proxy detects that the state of the downlink code resource between the HTTP Streaming Server and the HTTP Streaming Client is congested again, the HTTP proxy sends bit rate adjustment indication information that carries reduction indication information to the HTTP Streaming Client.

Step 46: After receiving the bit rate adjustment indication information that carries reduction indication information, the HTTP Streaming Client sends, according to the reduction indication information, a request for obtaining a fragment with the bit rate level of 470000 bps to the HTTP Streaming Server through the HTTP proxy. The HTTP Streaming Server responds to the request, and sends a fragment with the bit rate level of 470000 bps to the HTTP Streaming Client through the HTTP proxy.

According to the foregoing technical solution provided by the embodiment of the present invention, an HTTP proxy obtains state information of a code resource between an HTTP Streaming Client and an HTTP Streaming Server, and sends bit rate adjustment indication information that carries reduction indication information to the HTTP Streaming Client after the state of the code resource is congested, so that the HTTP Streaming Client can request the HTTP Streaming Server for a fragment of a media file with a bit rate level matching the code resource, thereby increasing utilization of air interface resources between the HTTP Streaming Client and the HTTP Streaming Server and improving user experience.

In addition, a bit rate adjustment timer is set to prevent frequent alarms due to code resource congestion.

### Embodiment 3

On an HTTP Server, multiple versions with different resolutions are constructed with respect to a whole media file, and the media files of versions corresponding to the resolutions are stored respectively. For example, resolution levels of the media file include 360p, 480p, and 720p. A page where the media file is located may include information such as a resource address of the media file with all the resolutions, where the resource address may be a URL (Uniform Resource Locator, Uniform Resource Locator). The HTTP Server sends the resource address of the media file to an HTTP Proxy and an HTTP Client through the page where the media file is located. If the HTTP Proxy has a file caching function, the HTTP Proxy may also directly obtain the resource address of the media file through a cache of the HPPT Proxy.

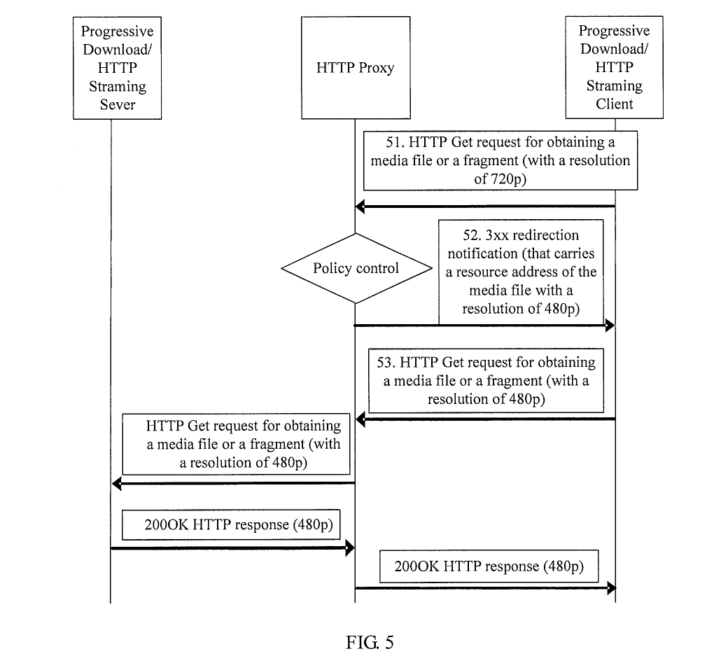

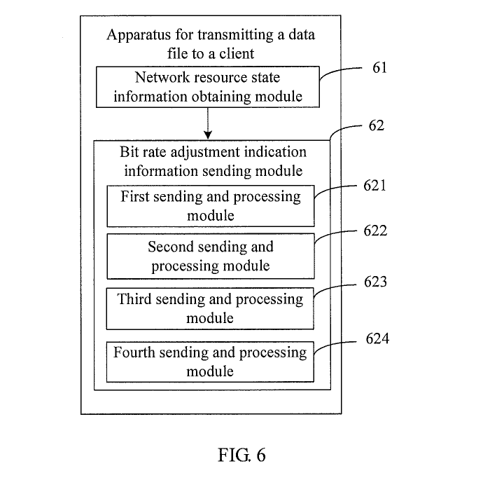

This embodiment provides a processing process of a method for transmitting a data file to a client. As shown in FIG. 5, the method includes the following processing steps:

Step 51: An HTTP Client using a Progressive Download (progressive download) mode sends, according to an obtained resource address of a media file, a request for obtaining a media file with a resolution of 720p to an HTTP Server through an HTTP Proxy.

Step 52: The HTTP Proxy detects, according to the detected state information of a downlink network resource between the HTTP Proxy and the HTTP Client, that the state of the downlink network resource between the HTTP Server and the HTTP Client is congested. Then, the HTTP Proxy sends a redirection notification that carries the resource address of the media file with a resolution of 480p.

The following is an example of carrying the resource address of the media file in the redirection notification by using an HTTP location header domain:

Location=“Location” “:” absolute URI.

HTTP GET request:

GET http://sever.example.com/media_{—}720p.flv HTTP/1.1

Accept: */*

Proxy-Connection: Keep-Alive

User-Agent: Mozilla/4.0 (compatible; MSIE 6.0; Windows NT 5.1; SV1)

Host: sever.example.com

Cookie:

A redirection notification replied by the HTTP Proxy is as follows:

HTTP/1.1 303 See Other

Proxy-Connection: Keep-Alive

Connection: Keep-Alive

Content-Length: 0

Via: 1.1 SZXISA06-IN

Date: Thu, 9 May 2011 03:31:53 GMT

Location: http://sever.example.com/media_{—}48p.flv

Content-Type: text/xml

Server: Microsoft-IIS/7.5

Step 53: After receiving the redirection notification, the HTTP Proxy obtains the resource address of the media file with the resolution level of 480p carried in the redirection notification. Then, the HTTP Streaming Client sends a request for obtaining a media file with the resolution level of 480p to the HTTP Streaming Server through the HTTP Proxy; the HTTP Streaming Server responds to the request, and sends a 200OK HTTP response and a media file with the resolution level of 480p to the HTTP Streaming Client through the HTTP Proxy.

According to the technical solution provided by the embodiment of the present invention, an HTTP proxy obtains state information of a network resource between a Progressive Download client and a Progressive Download sever, and sends a redirection notification that carries a resource address of a media file with a target resolution level to the Progressive Download client after the state of the network resource is congested, so that the Progressive Download client can request the Progressive Download Server for a media file with a resolution level matching the code resource, thereby increasing utilization of air interface resources between the HTTP Streaming Client and the HTTP Streaming Server and improving user experience.

An embodiment of the present invention also provides an apparatus for transmitting a data file to a client. This apparatus may be configured on an HTTP Proxy which is used as an intermediate layer between an HTTP Streaming Client and an HTTP Streaming Sever, or be configured on an HTTP Proxy which is used as an intermediate layer between a Progressive Download client and a Progressive Download sever. A specific structure of the apparatus is shown in FIG. 5, and includes the following modules:

a network resource state information obtaining module 61, configured to obtain state information of a network resource between a client and a server; and

a bit rate or resolution adjustment indication information sending module 62, configured to send bit rate or resolution adjustment indication information to the client according to the state information of the network resource obtained by the network resource state information obtaining module, so that the client can request the server for a data file with a bit rate or resolution matching the state information of the network resource.

Further, the network resource state information obtaining module 61 is also configured to obtain a value of a current downlink network resource between the client and the server, determine whether the value of the current downlink network resource is greater than a preset resource threshold; if the value is greater than the threshold, determine that the state of the downlink network resource between the client and the server is congested; otherwise, determine that the state of the downlink network resource between the client and the server is normal.

Specifically, the bit rate or resolution adjustment indication information sending module 62 may include:

a first sending and processing module 621, configured to: determine information about a bit rate or resolution of a data file matching the state information of the network resource and stored in the server; when the information about the bit rate or resolution of the data file requested by the client from the server is inconsistent with the information about the bit rate or resolution of the matched data file, send bit rate or resolution adjustment indication information that carries reduction or addition indication information to the client;

a second sending and processing module 622, configured to: determine information about a bit rate or resolution of a data file matching the state information of the network resource and stored in the server; when the information about the bit rate or resolution of the data file requested by the client from the server is inconsistent with the information about the matched bit rate or resolution of the data file, send a redirection notification message that carries a resource address of the matched data file to the client;

a third sending and processing module 623, configured to: when it is determined that the state of the downlink network resource between the client and the server is congested, send bit rate or resolution adjustment indication information that carries reduction indication information to the client; and

a fourth sending and processing module 624, configured to: when it is determined that the state of the downlink network resource between the client and the server is congested, determine a target bit rate or resolution after the bit rate or resolution of the data file requested by the client from the server is reduced, and send a redirection notification message that carries a resource address of the data file with the target bit rate or resolution.

A specific process of transmitting a data file to a client by using the apparatus according to the embodiment of the present invention is similar to the foregoing method embodiment, which is not further described herein.

A person of ordinary skill in the art can understand that all or some of the processes in the foregoing method embodiments may be implemented by related hardware instructed by a computer program. The program may be stored in a computer readable storage medium. When the program is executed, the processes of the foregoing method embodiments of the methods are involved. The storage medium may be a magnetic disk, an optical disc, a read-only memory (Read-Only Memory, ROM) or a random access memory (Random Access Memory, RAM), and the like.

In conclusion, in the embodiments of the present invention, a network side obtains state information of a network resource between a client and a server and sends bit rate or resolution adjustment indication information to the client according to the state information of the network resource, so that the client can request the server for a data file with a bit rate or resolution level matching the network resource, thereby increasing utilization of air interface resources between the server and the client and improving user experience.

By using the embodiments of the present invention, it can be detected in time that network resources such as a code resource, an IUB transmission resource, a credit resource, and a power resource between a client and a server are congested, and a bit rate or resolution reduction indication is sent to the client in time, thereby increasing an efficiency in transmitting a data file by the server.

In the embodiments of the present invention, an HTTP proxy is configured between an HTTP Streaming Client and an HTTP Streaming Server or between a Progressive Download client and a Progressive Download sever; and state information of a network resource between the HTTP Streaming Client and the HTTP Streaming Server or between the Progressive Download client and the Progressive Download sever is detected through the HTTP proxy, which can increase an efficiency of the HTTP Streaming Server in transmitting a data file to the HTTP Streaming Client or an efficiency of the Progressive Download sever in transmitting a data file to the Progressive Download client.

The foregoing descriptions are merely exemplary embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for transmitting a data file to a client, comprising storing a data file with different bit rates or resolutions in a server, wherein the method specifically comprises:
obtaining state information of a network resource between a client and a server; and
sending, according to the state information of the network resource, bit rate or resolution adjustment indication information to the client, so that the client requests the server for a data file with a bit rate or resolution matching the state information of the network resource.

2. The method for transmitting a data file to a client according to claim 1, wherein the storing a data file with different bit rates or resolutions in a server comprises:
splitting a data file into multiple fragments, constructing multiple versions with different bit rates or resolutions with respect to each fragment, and storing each fragment of the data file and description information of each fragment, wherein the description information of each fragment comprises information about the multiple bit rates or resolutions and a resource address corresponding to each fragment;
or,
constructing multiple versions with different bit rates or resolutions with respect to a whole data file, and storing the data file and description information of the data file, wherein the description information of the data file comprises information about the multiple bit rates or resolutions and a resource address corresponding to the data file.

3. The method for transmitting a data file to a client according to claim 1, wherein the obtaining state information of a network resource between a client and a server comprises:
obtaining a value of a current downlink network resource between the client and the server, and determining whether the value of the current downlink network resource value is greater than a preset resource threshold; if the value is greater than the threshold, determining that the state of the downlink resource between the client and the server is congested; otherwise, determining that the state of the downlink resource between the client and the server is normal.

4. The method for transmitting a data file to a client according to claim 1, wherein the sending, according to the state information of the network resource, bit rate or resolution adjustment indication information to the client comprises:
determining bit rate or resolution information of a data file matching the state information of the network resource and stored in the server; and
when the information about the bit rate or resolution of the data file requested by the client from the server is inconsistent with the information about the bit rate or resolution of the matched data file, sending bit rate or resolution adjustment indication information that carries reduction or addition indication information.

5. The method for transmitting a data file to a client according to claim 1, wherein the sending, according to the state information of the network resource, bit rate or resolution adjustment indication information to the client comprises:
determining information about a bit rate or resolution of a data file matching the state information of the network resource and stored in the server; and
when the information about the bit rate or resolution of the data file requested by the client from the server is inconsistent with the information about the bit rate or resolution information of the matched data file, sending a redirection notification message that carries a resource address of the matched data file to the client.

6. The method for transmitting a data file to a client according to claim 3, wherein the sending, according to the state information of the network resource, bit rate or resolution adjustment indication information to the client comprises:
when determining that the state of the downlink network resource between the client and the server is congested, sending bit rate or resolution adjustment indication information that carries reduction indication information to the client.

7. The method for transmitting a data file to a client according to claim 3, wherein the sending, according to the state information of the network resource, bit rate or resolution adjustment indication information to the client comprises:
when determining that the state of the downlink resource between the client and the server is congested, determining a target bit rate or resolution after the bit rate or resolution of the data file requested by the client from the server is reduced, and sending a redirection notification message that carries a resource address of the data file with the target bit rate or resolution.

8. An apparatus for transmitting a data file to a client, comprising:
a processor, configured to obtain state information of a network resource between a client and a server; and
a transmitter, configured to send bit rate or resolution adjustment indication information to the client according to the state information of the network resource obtained by the processor, so that the client can request the server for a data file with a bit rate or resolution matching the state information of the network resource.

9. The apparatus for transmitting a data file to a client according to claim 8, wherein:
the processor is further configured to obtain a value of the current downlink network resource between the client and the server, determine whether the value of the current downlink network resource is greater than a preset resource threshold; if the value is greater than the threshold, determine that the state of the downlink resource between the client and the server is congested; otherwise, determine that the state of the downlink resource between the client and the server is normal.

10. The apparatus for transmitting a data file to a client according to claim 8, wherein:
the processor is further configured to determine information about a bit rate or resolution of a data file matching the state information of the network resource and stored in the server;
the transmitter is specifically configured to send bit rate or resolution adjustment indication information that carries reduction or addition indication information to the client, when the information about the bit rate or resolution of the data file requested by the client from the server is inconsistent with the information about the bit rate or resolution of the matched data file.

11. The apparatus for transmitting a data file to a client according to claim 8, wherein:
the processor is further configured to determine information about a bit rate or resolution of a data file matching the state information of the network resource and stored in the server;
the transmitter is specifically send a redirection notification message that carries a resource address of the matched data file to the client, when the information about the bit rate or resolution of the data file requested by the client from the server is inconsistent with the information about the bit rate or resolution of the matched data file, sending a redirection notification message that carries a resource address of the matched data file to the client.

12. The apparatus for transmitting a data file to a client according to claim 8, wherein:
the processor is further configured to send bit rate or resolution adjustment indication information that carries reduction indication information to the client, when it is determined that the state of the downlink network resource between the client and the server is congested.

13. The apparatus for transmitting a data file to a client according to claim 8, wherein:
the processor is further configured to send a redirection notification message that carries a resource address of the data file with the target bit rate or resolution, when it is determined that the state of the downlink resource between the client and the server is congested, determine a target bit rate or resolution after the bit rate or resolution of the data file requested by the client from the server is reduced.
